(19) United States
(12) Patent Application Publication
(10) Pub. No.: US 2026/0082000 A1
(43) Pub. Date: Mar. 19, 2026

(54) CODE-BASED MANAGEMENT OF TECHNICAL SUPPORT FOR COMPUTER PERIPHERALS

(71) Applicant: Toshiba Tec Kabushiki Kaisha, Tokyo (JP)

(72) Inventor: Matthew CHAN, Irvine, CA (US)

(21) Appl. No.: 18/885,387

(22) Filed: Sep. 13, 2024

(51) Int. Cl. H04N 1/00; G06F 11/07

(52) U.S. Cl. CPC H04N 1/00079; G06F 11/0733; H04N 1/00076

(57) ABSTRACT

A computer system is configured to remotely manage technical support for a plurality of computer peripherals, by performing the steps of: monitoring network connections between the computer system and the plurality of computer peripherals to collect usage information and error information; and in response to detecting that a first error occurred in a computer peripheral of the plurality of computer peripherals: storing, in an entry of a database, error information describing an occurrence of the first error; generating a first support code and storing the first support code in the entry of the database in association with the error information; transmitting the first support code to the computer peripheral to be displayed thereby; reading the error information from the entry of the database in response to receiving the first support code from a user device; and displaying the error information on a user interface (UI) of a customer support technician.

### FIELD

Embodiments to be described herein generally relate to a computer system and a technical support management method for a computer system.

### BACKGROUND

Computer peripherals are external devices that connect to computers to provide additional functionalities or capabilities. For example, multi-function printers (MFPs) are computer peripherals that are capable of performing several functions such as printing, scanning, copying, and faxing. Users of computer peripherals encounter various errors during operation of the devices. Some of such errors, referred to herein as “critical errors,” prevent continued operation of the computer peripherals, e.g., preventing the performance of print operations, scan operations, copy operations, or fax operations. To resolve critical errors, users typically contact customer support technicians working for the manufacturers of the computer peripherals, e.g., by calling a technical support phone number. Others of such errors, referred to herein as “noncritical errors,” either do not prevent such operations or may be remedied without contacting customer support technicians. In the case of an MFP, an example of a noncritical error is a paper jam.

The process of working with customer support technicians is often difficult and tedious for users of computer peripherals. Users are typically required to collect a significant amount of details about their computer peripherals and about the errors thereof to explain to the technicians. For example, technicians may ask users about the serial numbers of their computer peripherals, parts inside the computer peripherals, where the computer peripherals are located, what types of operations the users typically use the computer peripherals for, error codes the computer peripherals display, etc. Some of such information may be difficult or time-consuming for the users to gather and provide to the technicians. Furthermore, if the users provide inaccurate information, the performance of technical support is hindered. A method of managing technical support is desired that reduces overhead for users and that improves the ability of technicians to quickly resolve critical errors.

### BRIEF DESCRIPTION OF THE DRAWINGS

FIG. 1 is a block diagram of a cloud environment and a user environment in which embodiments may be implemented.

FIG. 2 is a flow diagram of a method that may be performed by a computer system of the cloud environment to transmit a support code to a user of a computer peripheral in which a critical error has occurred, according to some embodiments.

FIG. 3 is a flow diagram of a method that may be performed by the computer system to manage the provision of remote technical support services to a user based on a support code, according to some embodiments.

FIG. 4 is a flow diagram of a method that may be performed by the computer system to create and train an artificial neural network for generating inferences about probabilities of computer peripherals encountering future critical errors, according to some embodiments.

FIG. 5 is a flow diagram of a method that may be performed by the computer system to provide a warning and recommendations to a user for operating a computer peripheral to prevent future critical errors, according to some embodiments.

### DETAILED DESCRIPTION

One or more embodiments provide a computer system including one or more computers each including a processor and memory, wherein the processors of the one or more computers execute instructions stored in the memory of the one or more computers to remotely manage technical support for a plurality of computer peripherals. The computer system performs the steps of: monitoring a plurality of network connections between the computer system and the plurality of computer peripherals to collect usage information and error information about the plurality of computer peripherals; and in response to detecting from the error information about the plurality of computer peripherals that a first error occurred in a computer peripheral of the plurality of computer peripherals, the first error being a critical error: storing, in an entry of a database, error information describing an occurrence of the first error; generating a first support code and storing the first support code in the entry of the database in association with the error information for the first error; transmitting the first support code to the computer peripheral to be displayed thereby; reading the error information for the first error from the entry of the database in response to receiving the first support code from a user device; and displaying, on a user interface (UI) of a customer support technician, the error information for the first error read from the entry of the database. Hereinafter, embodiments will be described with reference to the drawings. In the drawings, the same reference symbols denote the same or similar portions.

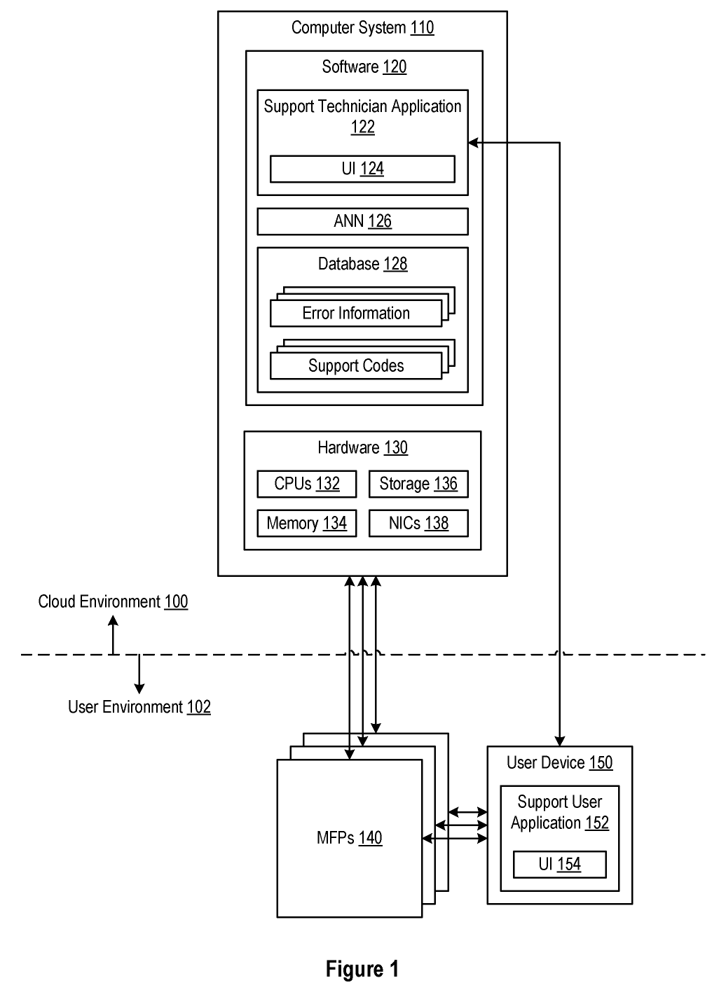

FIG. 1 is a block diagram of a cloud computing environment 100 and a user computing environment 102 in which embodiments may be implemented. For example, user environment 102 may be a workplace of a particular organization. Cloud environment 100 may be, e.g., a “public cloud,” including a public data center at which software is provisioned both for the organization of user environment 102 and for other organizations. In the example of FIG. 1, MFPs 140 are monitored from cloud environment 100 remotely from user environment 102. It should be noted, however, that embodiments are not limited to such example. For example, functionalities discussed herein as being performed in cloud environment 100 may be performed in a computing environment that does not provide cloud computing services, i.e., such functionalities need not be performed in a cloud computing environment. Additionally, while embodiments are described with reference to MFPs, it should be appreciated that embodiments are applicable to other computer peripherals.

Cloud environment 100 includes a computer system 110, which includes one or more computers such as server computers. Computer system 110 is constructed on hardware 130 such as an x86 architecture platform of a server computer (or of each of a plurality of server computers). Hardware 130 includes components of computers, such as central processing units (CPUs) 132, memory 134 such as random-access memory (RAM), storage 136 such as one or more magnetic drives or solid-state drives (SSDs), and network interface controllers (NICs) 138. CPUs 132 are configured to execute instructions such as executable instructions that perform one or more operations described herein, which may be stored in memory 134. NICs 138 enable computer system 110 to communicate with devices of user environment 102, e.g., over a wide area network (WAN) (not shown). Additionally, in the case of computer system 110 including a plurality of computers, NICs 138 enable the computers to communicate with each other, e.g., over a local area network (LAN) (not shown).

Hardware 130 supports software 120, including a support technician application 122, an artificial neural network (ANN) 126, and a database 128. Support technician application 122 is software that may be programmed to perform various operations described herein, including collecting error information about MFPs and communicating with user devices to manage the provision of technical support services. Support technician application 122 includes a UI 124 through which customer support technicians may access usage information and error information about MFPs. For example, the usage information and error information may be collected in JavaScript Object Notation (JSON) format.

As used herein, “usage information” about an MFP is information about the operation of the MFP, which may be collected both when an MFP is operating normally and when an MFP is encountering errors. Examples of usage information include identifiers of models of MFPs such as the manufacturers and serial numbers thereof, indicators of the performance of printing, copying, scanning, or faxing, and dates and times at which such operations are performed. As used herein, “error information” about an MFP is information describing the occurrence of a critical error that the MFP encountered during operation thereof. Examples of error information include error codes, which are, e.g., predefined numeric or alphanumeric values associated with types of errors. Error information may also include, e.g., identifiers of models of MFPs that encountered the errors, indicators of the performance of printing, copying, scanning, or faxing when the errors were encountered, and dates and times at which the errors occurred.

ANN 126 is a machine-learning model consisting of interconnected layers of nodes, referred to as “neurons.” A “neuron” is a fundamental unit or component of an ANN. Neurons in an ANN work together to process input data, transform it through layers of computation, and produce an output. As described further below, according to some embodiments, ANN 126 is trained to generate inferences about probabilities of MFPs encountering critical errors during operation. For example, based on usage information and error information collected from the MFPs, ANN 126 may generate predictions about whether the MFPs have a high likelihood of encountering critical errors in the near future, e.g., within the next month.

Database 128 is an organized collection of structured data used for providing technical support services to users of MFPs. Database 128 includes error information about MFPs at which critical errors have occurred. Database 128 further includes support codes, which are codes that are generated, e.g., by support technician application 122, for managing technical support services. For example, support codes may be numbers such as five-digit numbers that are randomly (or pseudo-randomly) generated using a random number generator. Each of the support codes of database 128 is associated with error information about a critical error that has occurred in an MFP.

User environment 102 includes a plurality of MFPs 140 and a user device 150. MFPs 140 are computer peripherals that are capable of performing several functions such as printing, scanning, copying, and faxing. MFPs 140 communicate with computer system 110 over one or more networks such as a WAN to provide usage information and error information to computer system 110. User device 150 is a computer such as a desktop computer, laptop computer, tablet computer, or smartphone. User device 150 is used by a user of MFPs 140, e.g., to send print jobs to MFPs 140 to be printed thereby, e.g., over a LAN.

User device 150 includes a support user application 152, which communicates with support technician application 122 to connect the user to a customer support technician when a critical error occurs in one of MFPs 140. Support user application 152 includes a UI 154 through which the user performs such communication. It should be noted that instead of a dedicated application for communicating with support technician application 122, the user may instead navigate to a technical support website using a web browser (not shown) installed on user device 150. Accordingly, functionalities described herein as being performed at support user application 152 may instead be performed using a web browser.

The combination of devices illustrated in user environment 102 are illustrated for example only, and embodiments are not limited thereto. For example, user environment 102 may only include a single MFP and/or may include a plurality of user devices at which multiple users access the MFP(s) of user environment 102. Additionally, although FIG. 1 only illustrates a single user environment, embodiments are similarly not limited thereto. Computer system 110 may communicate with a plurality of user environments to monitor MFPs in all the user environments and remotely provide technical support services to users therein.

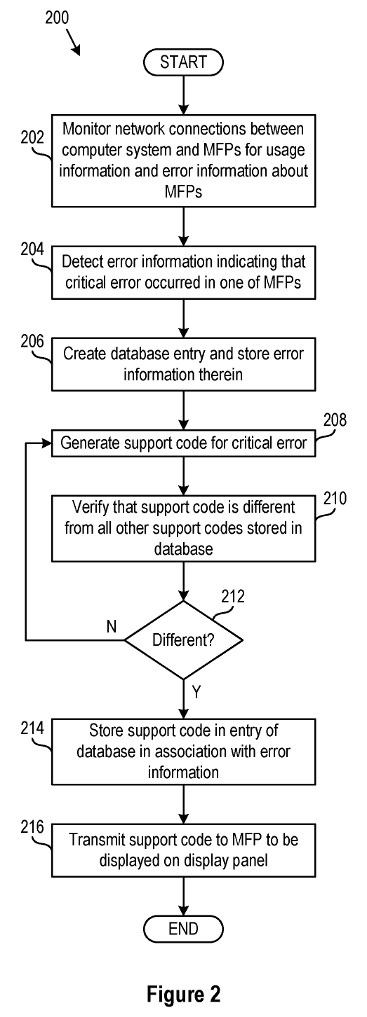

FIG. 2 is a flow diagram of a method 200 that may be performed by computer system 110 to transmit a support code to a user of a computer peripheral in which a critical error has occurred, according to some embodiments. Steps of method 200 will be discussed as being performed by support technician application 122. However, it should be noted that some of such steps may be performed by other applications of computer system 110. In other words, the performance of steps of method 200 may be divided between a plurality of applications instead of all being performed by support technician application 122. Additionally, for example, steps of method 200 will be discussed as being performed with respect to MFPs, but such steps are applicable to other computer peripherals.

At step 202, support technician application 122 monitors network connections such as WAN connections between computer system 110 and MFPs, including, e.g., MFPs 140 of user environment 102 and MFPs of other user environments. Specifically, support technician application 122 monitors the network connections for usage information and error information about the MFPs. At step 204, support technician application 122 detects error information indicating that a critical error occurred in one of the monitored MFPs. At step 206, support technician application 122 creates a new entry in database 128 and stores the error information in the new entry.

At step 208, support technician application 122 generates a support code for the critical error. For example, support technician application 122 may randomly (or pseudo-randomly) generate the support code. Additionally, for example, support technician application 122 may generate the support code in response to receiving a request for the support code from the MFP at the which the critical error has occurred. As another example, support technician application 122 may automatically generate the support code in response to detecting the error information.

At step 210, support technician application 122 verifies that the generated support code is different from all other support codes that are currently stored in database 128. At step 212, if the generated support code matches one of the support codes in database 128, method 200 returns to step 208, and support technician application 122 generates another support code, e.g., randomly or pseudo-randomly. Returning to step 212, if the generated support code is different from all the support codes in database 128, method 200 moves to step 214. At step 214, support technician application 122 stores the support code in the new entry of database 128 in association with the error information previously stored in the entry. At step 216, support technician application 122 transmits the support code to the MFP at which the critical error has occurred to be displayed on a display panel of the MFP.

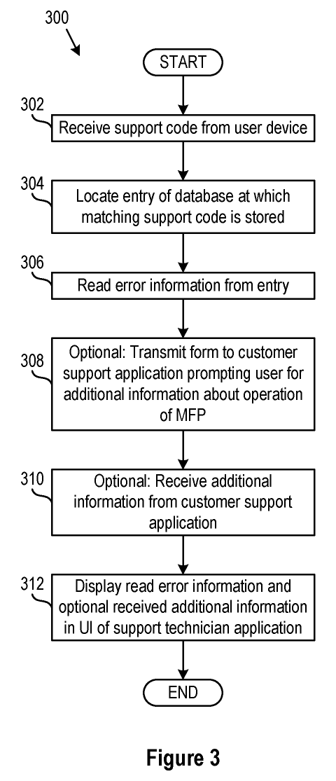

After step 216, method 200 ends. After method 200, the user of the MFP may use the support code to obtain technical support for resolving the critical error, as discussed below in conjunction with FIG. 3. It should be noted that after method 200, support technician application 122 may generate a new support code for a critical error for security purposes. Generating a new support code improves security by thwarting an attacker that determines an old support code, e.g., by guessing several different codes. Generating a new support code may prevent such attacker from using the compromised support code to impersonate a user and, e.g., request confidential information about the user from support technician application 122.

For example, support technician application 122 may generate a new support code in response to a predetermined amount of time elapsing after the generating of a previous support code. As another example, support technician application 122 may generate a new support code in response to receiving a request from user device 150 to generate the new support code. The user may click a button in UI 154 of support user application 152 to cause user device 150 to transmit the request. As another example, in the case of the support code being a single-use code, support technician application 122 may generate a new support code in response to user device 150 using the support code by transmitting the support code to support technician application 122.

After method 200, if support technician application 122 generates a new support code, steps 214 and 216 may be repeated with the new support code. Support technician application 122 stores the new support code in place of the previous support code in the same entry of database 128 in association with the error information. Support technician application 122 also transmits the new support code to the MFP to be displayed on the display panel. Such optional functionality may be used to protect a user, e.g., from exposure of confidential information.

FIG. 3 is a flow diagram of a method 300 that may be performed by computer system 110 to manage the provision of remote technical support services to a user based on a support code, according to some embodiments. For example, method 300 will be discussed with respect to providing such services for one of MFPs 140 at which a critical error has occurred, but method 300 is applicable to another computer peripheral at which a critical error has occurred. Additionally, steps of method 300 will be discussed as being performed by support technician application 122. However, some of such steps may be performed by other applications of computer system 110.

At step 302, support technician application 122 receives a support code from user device 150. For example, the user may read the support code from the display panel of MFP 140 and enter the support code via UI 154 of support user application 152. User device 150 may then transmit the entered support code to support technician application 122. At step 304, support technician application 122 locates an entry of database 128 at which a matching (e.g., identical) support code is stored.

At step 306, support technician application 122 reads error information from the located entry. It should be noted that such error information was automatically collected by support technician application 122 upon the critical error occurring in MFP 140. The user does not manually provide the error information to support technician application 122, thus reducing overhead for the user in acquiring technical support. Furthermore, such automatically collected information is reliable (likely accurate), thus improving the ability of a technician to quickly resolve the critical error.

At step 308, as an optional step, support technician application 122 transmits a form to support user application 152 prompting the user for additional information about the MFP. For example, while the automatically collected error information from database 128 may provide enough context for a technician to diagnose a critical error, a user may provide additional context as notes. Such additional information may enable a support technician to more quickly diagnose the problem that caused the critical error and to resolve the critical error. Additionally, the user may provide contact information such as an email address and phone number for a technician to contact. At step 310, as another optional step, support technician application 122 receives the additional information from support user application 152. For example, the user may manually enter the information via UI 154.

At step 312, support technician application 122 displays, via UI 124, the error information read from database 128. For example, a customer support technician may view UI 124 on a screen of a computer of the technician such as a laptop computer. Additionally, if support technician application 122 received additional information, support technician application 122 displays the additional information via UI 124. After step 312, method 300 ends, and a support technician views the error information (and optional additional information) via UI 124. Such displaying enables the customer support technician to determine how to resolve the critical error. The technician may then, e.g., call or email the user to explain steps to perform to resolve it.

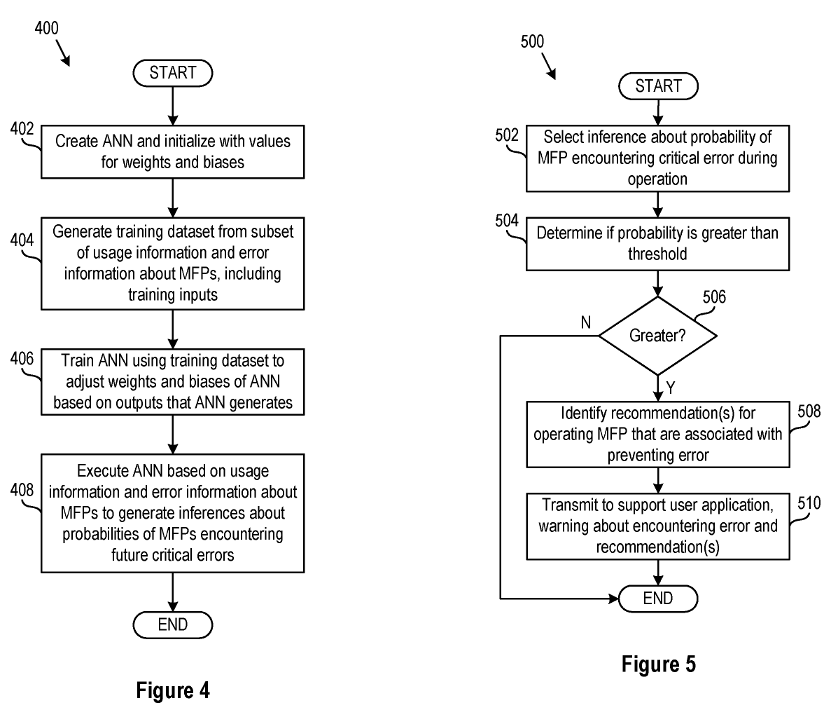

FIG. 4 is a flow diagram of a method 400 that may be performed by computer system 110 to create and train ANN 126 for generating inferences about probabilities of computer peripherals encountering future critical errors, according to some embodiments. Steps of method 400 will be discussed as being performed by support technician application 122. However, some of such steps may be performed by other applications of computer system 110. Additionally, for example, steps of method 400 will be discussed as being performed with respect to MFPs, but such steps are applicable to other computer peripherals. At step 402, support technician application 122 creates ANN 126 and initializes ANN 126 with values for weights and biases thereof, e.g., by sampling from a distribution such as a normal distribution with a predetermined mean and variance. The weights are numerical values associated with connections between neurons of ANN 126, and the biases are numerical values added to outputs of neurons.

At step 404, support technician application 122 generates a training dataset from a subset of usage information and error information about MFPs such as MFPs 140, the usage information and error information being collected from the MFPs. The training dataset includes training inputs, such as models of MFPs, modes of the MFPs such as being powered on or in a sleep mode, and status information about the MFPs such as amounts of ink or toner remaining, whether a type of printing is enabled such as color printing or duplex printing, and if the MFPs are connected to a network. The training inputs may also include event information about the MFPs performing operations such as printing, scanning, copying, and faxing. In the case of supervised training, the training dataset also includes expected outputs corresponding to the training inputs. For example, for a set of training inputs in an entry of the dataset, an expected output may be either an error code associated with the training inputs of the entry or an indication of normal MFP operation associated with the training inputs of the entry. Such training inputs and expected outputs may be converted to numbers before being used for training ANN 126.

At step 406, support technician application 122 trains ANN 126 using the training dataset to adjust weights and biases of ANN 126 based on outputs that ANN 126 generates. During each iteration of the training, after input values are inputted to ANN 126, ANN 126 performs operations in and between layers thereof based on its weights and biases, e.g., multiplying values by weights between layers and adding values to biases and performing activation functions in the layers. An error is then computed using a loss function based on the output values from ANN 126. For example, in the case of supervised training, the output values from ANN 126 are compared to the corresponding expected output values from the dataset to compute the error. Then, the error is used for updating the weights and biases in a manner that reduces future error of ANN 126 at generating outputs.

At step 408, support technician application 122 executes ANN 126 based on usage information and error information about MFPs such as those received from MFPs 140. Based on such execution, ANN 126 generates inferences about probabilities of such MFPs encountering future critical errors during operation. For example, for one MFP, ANN 126 may generate an inference indicating that the MFP is not likely to encounter any critical errors, e.g., in the next month. As another example, for another MFP, ANN 126 may generate an inference indicating that the MFP is likely to encounter a particular critical error or multiple critical errors, e.g., in the next month. After step 408, method 400 ends.

FIG. 5 is a flow diagram of a method 500 that may be performed by computer system 110 to provide a warning and recommendations to a user for operating a computer peripheral to prevent future critical errors, according to some embodiments. Steps of method 500 will be discussed as being performed by support technician application 122. However, some of such steps may be performed by other applications of computer system 110. Additionally, for example, steps of method 500 will be discussed as being performed with respect to MFPs, but such steps are applicable to other computer peripherals.

At step 502, support technician application 122 selects an inference from ANN 126 about the probability of an MFP such as one of MFPs 140 encountering a critical error. At step 504, support technician application 122 determines if the probability is greater than a threshold such as a predetermined percentage. At step 506, if the probability is not greater than the threshold, method 500 ends. Otherwise, at step 506, if the probability is greater than the threshold, method 500 moves to step 508.

At step 508, support technician application 122 identifies one or more recommendations for operating the MFP that are associated with preventing the error. For example, support technician application 122 may identify a recommendation to distribute print jobs between multiple trays of the MFP instead of continuing to exclusively use the same tray, which may extend the lifetime of the trays. For example, support technician application 122 may maintain a list of such recommendations and select those recommendations that are relevant to any critical errors that ANN 126 has identified as being likely to occur in the MFP.

At step 510, support technician application 122 transmits a warning to support user application 152 about the risk of encountering the critical error. Support technician application 122 also transmits the identified recommendation(s) to support user application 152. Support user application 152 displays the warning and recommendation(s) via UI 154. After step 510, method 500 ends. Method 500 may be performed at any time as support technician application 122 collects usage information and error information about MFPs and ANN 126 generates inferences about the probabilities of the MFPs encountering critical errors.

While certain embodiments have been described, these embodiments have been presented by way of example only, and are not intended to limit the scope of the invention. Indeed, the novel embodiments described herein may be embodied in a variety of other forms. Furthermore, various omissions, substitutions, and changes in the form of the embodiments described herein may be made without departing from the spirit of the invention. The accompanying claims and their equivalents are intended to cover such forms or modifications as would fall within the scope and spirit of the invention.

What is claimed is:

1. A computer system including one or more computers each including a processor and memory, wherein the processors of the one or more computers execute instructions stored in the memory of the one or more computers to remotely manage technical support for a plurality of computer peripherals, by performing the following steps:
monitoring a plurality of network connections between the computer system and the plurality of computer peripherals to collect usage information and error information about the plurality of computer peripherals; and
in response to detecting from the error information about the plurality of computer peripherals that a first error occurred in a computer peripheral of the plurality of computer peripherals, the first error being a critical error:
storing, in an entry of a database, error information describing an occurrence of the first error;
generating a first support code and storing the first support code in the entry of the database in association with the error information for the first error;
transmitting the first support code to the computer peripheral to be displayed thereby;
reading the error information for the first error from the entry of the database in response to receiving the first support code from a user device; and
displaying, on a user interface (UI) of a customer support technician, the error information for the first error read from the entry of the database.

2. The computer system of claim 1, wherein the plurality of computer peripherals is a plurality of MFPs, and the computer peripheral is an MFP of the plurality of MFPs, and the steps further include:
creating an artificial neural network (ANN) and initializing the ANN with values for weights and biases of the ANN;
generating a training dataset from a subset of the usage information and the error information about the plurality of MFPs, wherein each entry of the training dataset includes training inputs, including an identifier of an MFP model and an event of performing one of a print operation, a scan operation, a copy operation, and a fax operation;
training the ANN using the training dataset to adjust the weights and biases of the ANN, based on outputs that the ANN generates by performing operations in and between layers of the ANN based on the weights and biases of the ANN; and
executing the ANN based on the usage information and the error information about the plurality of MFPs to generate inferences about probabilities of the plurality of MFPs encountering future errors during operation.

3. The computer system of claim 2, wherein the steps further include:
generating the training dataset to include, for each of the entries of the training dataset, an expected output, including either (1) an error code associated with the training inputs of the entry, or (2) an indication of normal MFP operation associated with the training inputs of the entry; and
training the ANN using supervised training based on comparisons between the outputs that the ANN generates and the expected outputs from the training dataset.

4. The computer system of claim 3, wherein the steps further include:
executing the ANN to generate an inference that the probability of the MFP encountering a second error is greater than a threshold; and
transmitting a warning about encountering the second error to the user device.

5. The computer system of claim 4, wherein the steps further include:
identifying one or more recommendations for operating the MFP that are associated with preventing the second error; and
transmitting the one or more recommendations to the user device.

6. The computer system of claim 1, wherein the steps further include:
generating the first support code using a random number generator; and
verifying that the first support code is different from all other support codes stored in the database before transmitting the first support code to the computer peripheral.

7. The computer system of claim 1, wherein the steps further include:
transmitting a form to the user device in response to receiving the first support code from the user device, wherein the form prompts a user of the computer peripheral for additional information about the computer peripheral; and
displaying, upon receiving the additional information from the user device, the additional information on the UI of the customer support technician.

8. The computer system of claim 1, wherein the steps further include:
generating a second support code in response to a predetermined amount of time elapsing after the generating of the first support code, and storing the second support code in the entry of the database in association with the error information for the first error; and
transmitting the second support code to the computer peripheral to be displayed thereby.

9. The computer system of claim 1, wherein the steps further include:
generating a second support code in response to receiving a request from the user device to generate the second support code, and storing the second support code in the entry of the database in association with the error information for the first error; and
transmitting the second support code to the computer peripheral to be displayed thereby.

10. The computer system of claim 1, wherein the steps further include:
generating a second support code in response to receiving the first support code from the user device; and
transmitting the second support code to the computer peripheral to be displayed thereby.

11. A technical support management method for a computer system to remotely manage technical support for a plurality of computer peripherals, the technical support management method comprising:
monitoring a plurality of network connections between the computer system and the plurality of computer peripherals to collect usage information and error information about the plurality of computer peripherals; and
in response to detecting from the error information about the plurality of computer peripherals that a first error occurred in a computer peripheral of the plurality of computer peripherals, the first error being a critical error:
storing, in an entry of a database, error information describing an occurrence of the first error;
generating a first support code and storing the first support code in the entry of the database in association with the error information for the first error;
transmitting the first support code to the computer peripheral to be displayed thereby;
reading the error information for the first error from the entry of the database in response to receiving the first support code from a user device; and
displaying, on a user interface (UI) of a customer support technician, the error information for the first error read from the entry of the database.

12. The technical support management method of claim 11, wherein the plurality of computer peripherals is a plurality of MFPs, and the computer peripheral is an MFP of the plurality of MFPs, the technical support management method further comprising:
creating an artificial neural network (ANN) and initializing the ANN with values for weights and biases of the ANN;
generating a training dataset from a subset of the usage information and the error information about the plurality of MFPs, wherein each entry of the training dataset includes training inputs, including an identifier of an MFP model and an event of performing one of a print operation, a scan operation, a copy operation, and a fax operation;
training the ANN using the training dataset to adjust the weights and biases of the ANN, based on outputs that the ANN generates by performing operations in and between layers of the ANN based on the weights and biases of the ANN; and
executing the ANN based on the usage information and the error information about the plurality of MFPs to generate inferences about probabilities of the plurality of MFPs encountering future errors during operation.

13. The technical support management method of claim 12, further comprising:
generating the training dataset to include, for each of the entries of the training dataset, an expected output, including either (1) an error code associated with the training inputs of the entry, or (2) an indication of normal MFP operation associated with the training inputs of the entry; and
training the ANN using supervised training based on comparisons between the outputs that the ANN generates and the expected outputs from the training dataset.

14. The technical support management method of claim 13, further comprising:
executing the ANN to generate an inference that the probability of the MFP encountering a second error is greater than a threshold; and
transmitting a warning about encountering the second error to the user device.

15. The technical support management method of claim 14, further comprising:
identifying one or more recommendations for operating the MFP that are associated with preventing the second error; and
transmitting the one or more recommendations to the user device.

16. The technical support management method of claim 11, further comprising:
generating the first support code using a random number generator; and
verifying that the first support code is different from all other support codes stored in the database before transmitting the first support code to the computer peripheral.

17. The technical support management method of claim 11, further comprising:
transmitting a form to the user device in response to receiving the first support code from the user device, wherein the form prompts a user of the computer peripheral for additional information about the computer peripheral; and
displaying, upon receiving the additional information from the user device, the additional information on the UI of the customer support technician.

18. The technical support management method of claim 11, further comprising:
generating a second support code in response to a predetermined amount of time elapsing after the generating of the first support code, and storing the second support code in the entry of the database in association with the error information for the first error; and
transmitting the second support code to the computer peripheral to be displayed thereby.

19. The technical support management method of claim 11, further comprising:
generating a second support code in response to receiving a request from the user device to generate the second support code, and storing the second support code in the entry of the database in association with the error information for the first error; and
transmitting the second support code to the computer peripheral to be displayed thereby.

20. The technical support management method of claim 11, further comprising:
generating a second support code in response to receiving the first support code from the user device; and
transmitting the second support code to the computer peripheral to be displayed thereby.
